(19) United States
(12) Patent Application Publication
(10) Pub. No.: US 2023/0087369 A1
(43) Pub. Date: Mar. 23, 2023

(54) TRACK SHOE OR TRACK BOLT WITH INCREASED SURFACE ROUGHNESS

(71) Applicant: Caterpillar Inc., Peoria, IL (US)

(72) Inventor: Eric James Johannsen, Washington, IL (US)

(73) Assignee: Caterpillar Inc., Peoria, IL (US)

(21) Appl. No.: 17/480,710

(22) Filed: Sep. 21, 2021

(51) Int. Cl. B62D 55/26; B62D 55/21

(52) U.S. Cl. CPC B62D 55/26; B62D 55/21

(57) ABSTRACT

A track shoe includes a ground engaging surface, and a track link engaging surface. A hole extends through the shoe from the ground engaging surface to the track link engaging surface. The ground engaging surface includes a first region disposed adjacent the hole, and a second region extending from the first region away from the hole having a different surface roughness than the first surface roughness.

### TECHNICAL FIELD

The present disclosure relates generally to track shoes and track bolts that are employed to assemble track chains used on endless track drive vehicles. More particularly, the present disclosure relates to such track shoes and track bolts that are less likely over time to loosen due to vibration, loads and wear.

### BACKGROUND

Track type machines typically utilize track chains on each side of the machine that engage the ground surface during propulsion of the machine. A plurality of individual links are pivotably coupled via bushing and pin arrangements to form the track chain. A sprocket, driven by an engine of the machine, engages the bushings and translates the chain about one or more idlers. As the chain translates, the connected links engage a ground surface under the machine, for example, via coupled track shoes, and propel the machine on the surface. Track chains can be straight link chains with alternating inner and outer links or can be offset link chains where all the links are alike. The track shoes are typically connected to the links by a bolt and nut arrangement. Over time, these fastened connections may become loose due to vibration, loads, wear, etc. If the shoe becomes improperly positioned or falls of the track chain, damage to the undercarriage and/or undesirable downtime for maintenance is necessary.

One way to handle this problem is to use high minimum torque requirements to improve bolt retention and clamping force. High minimum torque requirements can help reduce bolt loosening but can place the bolts at risk of over tightening and fracture. Further, high minimum torque requirements do not necessarily increase bolt clamping force as various friction forces between the bolt and the track shoe surfaces can significantly reduce resultant bolt clamping force despite applied tightening torque.

Another proposed solution is contained in U.S. Pat. Nos. 9,732,782, 10,508,679 that disclose a wedge locking washer that may help prevent the loosening of the threaded connection. More specifically, the surface of the washer may be provided with a pattern to increase the friction between the washer and a screw head, nut, or a bolt, etc. However, such washers may be easily lost or may not be available in the field when maintenance is needed.

Accordingly, there is exists a need for a device that reduces the likelihood of track bolt loosening that is more convenient and reliable for the user.

### SUMMARY

A track shoe for use with a track assembly according to an embodiment of the present disclosure is provided. The track shoe may comprise a ground engaging surface, and a track link engaging surface. A hole may extend through the shoe from the ground engaging surface to the track link engaging surface. The ground engaging surface includes a rough region disposed adjacent the hole having a surface roughness of 4.0 Ra or greater.

A track shoe for use with a track assembly according to another embodiment of the present disclosure is provided. The track shoe may comprise a ground engaging surface, and a track link engaging surface. A hole may extend through the shoe from the ground engaging surface to the track link engaging surface. The ground engaging surface includes a first region disposed adjacent the hole, and a second region extending from the first region away from the hole having a different surface roughness than the first surface roughness.

A track bolt for use with a track assembly according to an embodiment of the present disclosure is provided. The track bolt may comprise a head, and a shaft extending from the head. The head may include a underside surface that surrounds the shaft and that includes a surface roughness that is 4.0 Ra or greater.

### BRIEF DESCRIPTION OF THE DRAWINGS

FIG. 1 is a perspective view of an exemplary machine such as a bulldozer or the like with an elevated track drive assembly.

FIG. 2 is an enlarged rear view of a portion of the elevated track drive assembly removed from the machine of FIG. 1, showing track bolts attaching the track shoes to the track chain more clearly.

FIG. 3 is an enlarged sectional view illustrating the track bolt extending through a punched bore of the track shoe. An area of increased surface roughness is shown under the head of the bolt.

FIG. 4 is a top view of the bore of FIG. 3 with the bolt removed, showing an area of increased surface roughness (e.g., a stipple pattern) disposed about the bore.

FIG. 5 is a top view of another track shoe showing an area of increased roughness having a different pattern (e.g., a knurling pattern) than that of FIG. 4.

FIG. 6 is a perspective view of a track bolt with a surface of increased roughness disposed underneath its head. A stipple pattern is shown.

FIG. 7 is a perspective view of another track bolt with a surface increased roughness disposed underneath its head. A knurled pattern is show

FIG. 8 is a perspective view of a punch that may form the pattern illustrated about the bore in FIG. 5.

FIG. 9 illustrates a sawtooth profile that formed on the surface of the track shoe that would be under the bolt head to help prevent rotation of the bolt in a loosening direction.

### DETAILED DESCRIPTION

Both the foregoing general description and the following detailed description are exemplary and explanatory only and are not restrictive of the features, as claimed. As used herein, the terms “comprises,” “comprising,” “having,” “including,” or other variations thereof, are intended to cover a non-exclusive inclusion such that a process, method, article, or apparatus that comprises a list of elements does not include only those elements but may include other elements not expressly listed or inherent to such a process, method, article, or apparatus. In this disclosure, relative terms, such as, for example, “about,” “substantially,” and “approximately” are used to indicate a possible variation of ±10% in the stated value.

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or by a prime for example, 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters and primes will often not be included herein but may be shown in the drawings to indicate duplications of features, having similar or identical function or geometry, discussed within this written specification.

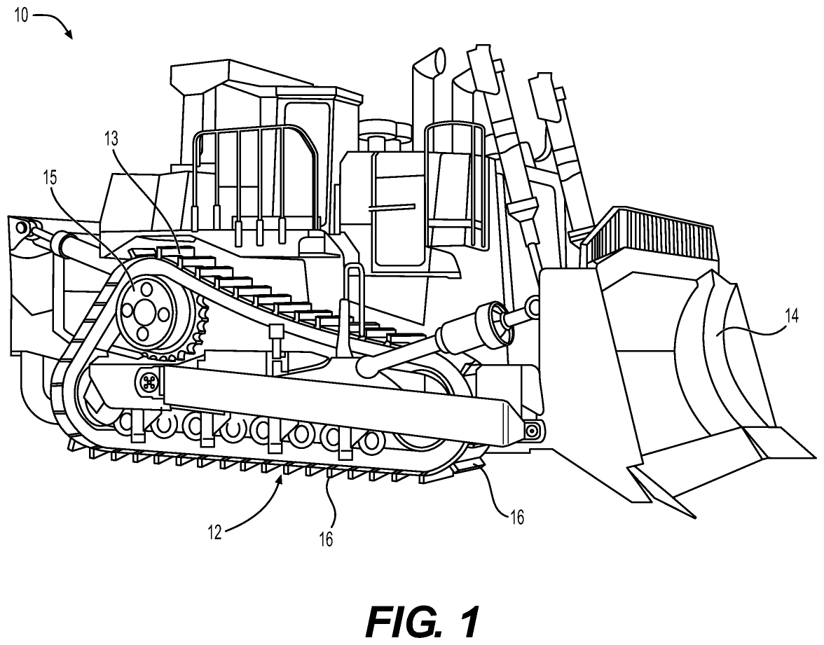

FIG. 1 illustrates a machine 10 with a track assembly 12 according to the present disclosure. Machine 10 may be a track-type tractor or any mobile machine that performs some type of operation with an industry, such as mining, construction, farming, transportation, or any other industry known in the art, for example, a dozer, an excavator, a loader, a backhoe, a motor grader, or any other earth moving machine. A work implement in the form of a blade 14 is shown, but other work implements may be used or may be omitted altogether.

In one aspect, machine 10 may be a bulldozer as shown. In other aspects, however, machine 10 may be a small track-type tractor or a large track-type tractor, etc. Track drive assembly 12, which may have a track link assembly or a track chain assembly 13, may be coupled to an undercarriage assembly of machine 10 and driven by a machine engine or other power source (not shown) via at least one drive gear or sprocket 15. A separate track drive assembly 12 may be coupled to each side of machine 10, with each having a track chain 13 forming separate endless loops. A plurality of track shoes 16 may be coupled to an outer surface of track chain 13 in order to aid in the engagement of the ground surface.

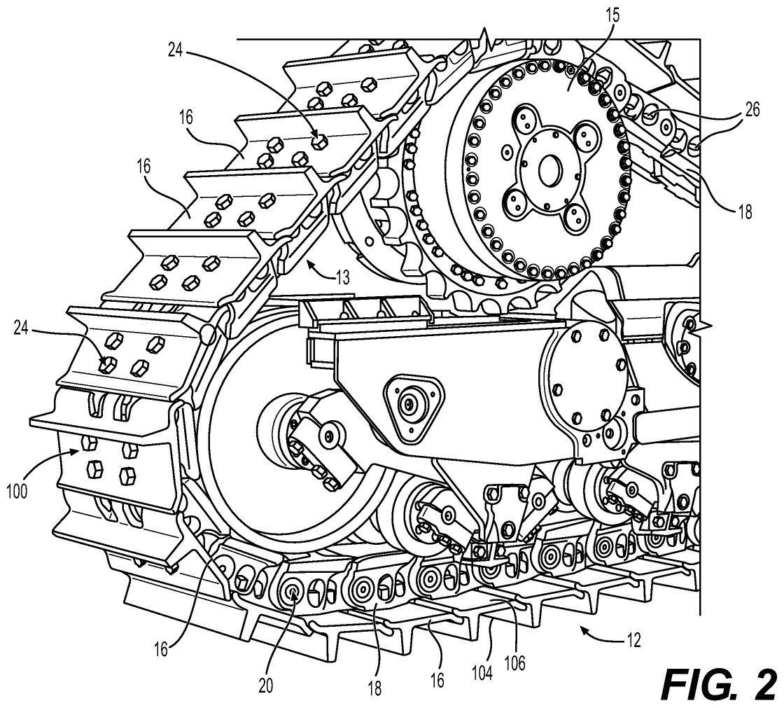

As best seen in FIG. 2, the track chain 13 may include multiple structurally similar link subassemblies, each of which may include a pair of links. A pair of links may include a link 18 and a respectively paired link that is parallel and spaced opposite from link 18. Links 18 and their respectively paired links may be straight or offset links, and each include apertures at respective opposite ends (e.g., a first-end aperture and a second-end aperture).

Successive link subassemblies may be coupled by a pin 20 and a bushing (not shown). For example, to couple a first link subassembly with a successive a second link subassembly, pin 20 may be fixedly received in the first-end apertures of the links of the first link subassembly and bushing may be fixedly received in the second-end apertures of the links of the second link assembly. As such, pin 20 and bushing couple two link subassemblies together to form a portion of track chain 13.

Each pin 20 may be a substantially cylindrical rod and may be sized to be slip fit through bushing. Each bushing may be generally cylindrical, with a cylindrical channel extending longitudinally through bushing as a bore. The bore and the pin may have a constant diameters, but not necessarily so.

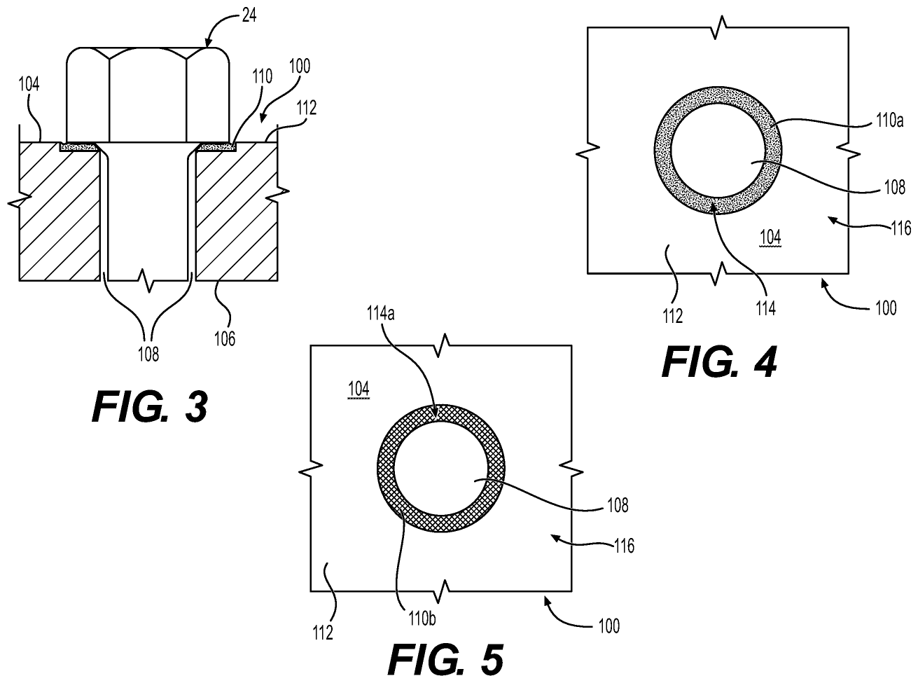

Looking at FIGS. 2 and 3, the track shoes 16, 100 are often fastened to the links of the assembly using a track bolt 24 that extends through a hole 108 of the track shoe 100 as alluded to earlier herein. The threaded end of the track bolt 24 is connected to a nut 26 found in a recess or void of the link.

The particulars of various embodiments of a track shoe and/or a track bolt configured according to various embodiments of the present disclosure will now be discussed that have features that reduce the likelihood of a bolted connection or other fastened connection between the track shoe, the track bolt, the nut, etc. from loosening.

The inventor has discovered that the friction between the head of a bolt or other portion of a fastener and the track shoe has as much an effect on the robustness of the fastened connection as any other variable.

Referring now to FIGS. 3 thru 5, the track shoe 100 may comprise a ground engaging surface 104, a track link engaging surface 106, and a hole 108 (may also be referred to as a “fastener receiving aperture”) extending through the track shoe 100 from the ground engaging surface 104 to the track link engaging surface 106. The ground engaging surface 104 may include a rough region 110, 110a, 110b disposed adjacent the hole 108 having a surface roughness of 4.0 Ra or greater in some embodiments. In such a case, the surface roughness of this rough region 110, 110a, 110b may be less than 10.0 Ra. This may not be the case in other embodiments of the present disclosure.

In some embodiments, the ground engaging surface 104 may include a smooth region 112 that is disposed adjacent the rough region. This smooth region 112 may have a surface roughness less than 4.0 Ra in some embodiments of the present disclosure.

As best seen in FIGS. 4 and 5, the rough region 110, 110b may encircle the hole, while the smooth region 112 may encircle the rough region. The region may thus form various shapes including any suitable annular ring shape (e.g., may be circular, square, etc.). These spatial relationships may be differently configured in other embodiments of the present disclosure.

In some embodiments, the increased surface roughness may be achieved using a stipple pattern/texture, a knurled pattern/texture, a sawtooth pattern (see FIG. 9), etc.

In some embodiments, the track shoe 100 may have a surface roughness that varies and/or may have areas where the surface roughness is too great. In such a case, the ground engaging surface 104 may include a first region 114, 114a surrounding the hole (see FIGS. 4 and 5), and a second region 116 extending from the first region away from the hole 108 having a different surface roughness than the first surface roughness. In such a case, the difference in surface roughness may be at least 5.0 Ra. Other values in this difference are possible in other embodiments of the present disclosure.

In some cases, the first region 114, 114a has a greater surface roughness than the second region 116, but not necessarily so. The first region 114, 114a may have various configurations including a circular ring shape as shown in FIGS. 4 and 5.

As understood with reference to FIG. 2, there are typically a plurality of holes 108, each including an associated first region 114, 114a disposed about the hole. In such a case, the second region 116 may cover a majority of the track shoe, extending from the first region of one hole to the first region of another hole, etc.

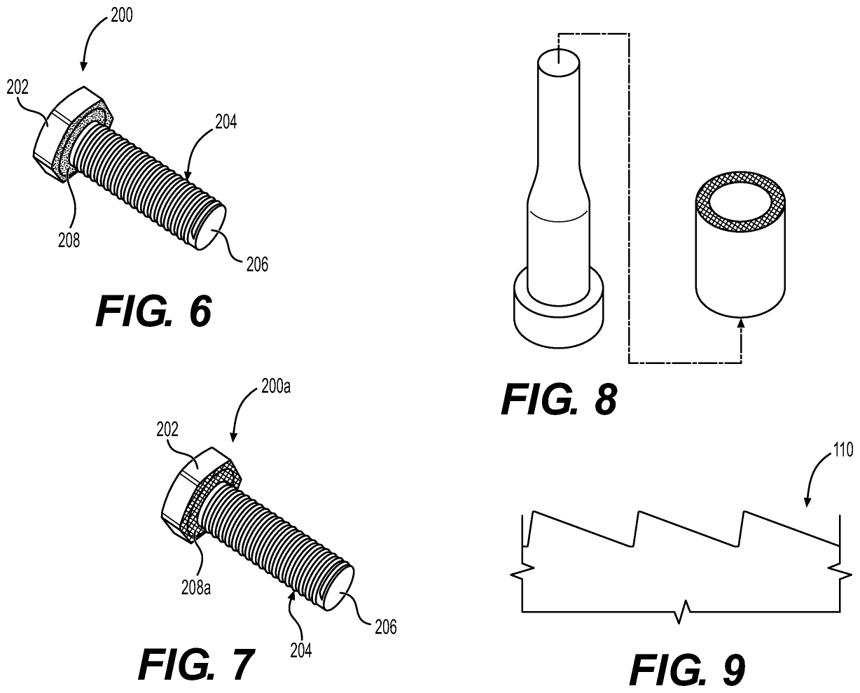

In addition to or in lieu of the frictional features of the track shoe, the track bolt 200, 200a may also have frictional features. More particularly as shown in FIGS. 6 and 7, the track bolt 200 may include a head 202, and a shaft 204 extending from the head 202, terminating at a free end 206. As shown, the entire shaft may be externally threaded, but not necessarily so. For example, there may be unthreaded portion disposed between the head and the threaded portion that extends from free end (e.g., see FIG. 3). The head 202 may include a surface 208, 208a under the head that surrounds the shaft 204, having a surface roughness that is 4.0 Ra or greater. This surface roughness may be achieved using any of the textures/patterns previously discussed herein (e.g., sawtooth, stipple, knurled, etc.). In some embodiments, this surface roughness may not exceed 10.0 Ra.

While not discussed in detail herein, these same features may be applied at the interface between a nut and track shoe, a nut and the track link, etc.

In general, any component discussed herein may be made from any suitable material, including, but not limited to, iron, steel, cast-iron, grey-cast iron, white iron, etc. Also, any component discussed herein may be heat treated, induction hardened, carburized, coated, etc.

### INDUSTRIAL APPLICABILITY

A track shoe, a track bolt, a nut, or any assembly including one or more of these components according to any embodiment discussed herein may be provided as a replacement part in the field or in an OEM (Original Equipment Manufacturer) context.

A punching/stamping process may be used to form the hole, and the pattern or texture around the hole to provide the requisite surface roughness. To that end, FIG. 8 shows a punch and a sleeve that has a knurling pattern or texture so as the tip of the punch suddenly plunges through the shoe and forms the hole, the annular surface of the sleeve contacts the shoe and imparts the texture or pattern. The combination of the punch and sleeve may take the form of a spring loaded plunger with a hard stop. Alternatively, a more sophisticated manufacturing technique such as EDM (electrical discharge machining), etc. may be used in other embodiments of the present disclosure to form the texture or pattern.

As used herein, the articles “a” and “an” are intended to include one or more items, and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

What is claimed is:

1. A track shoe for use with a track assembly, the track shoe comprising:
a ground engaging surface;
a track link engaging surface; and
a hole extending through the track shoe from the ground engaging surface to the track link engaging surface;
wherein the ground engaging surface includes a rough region disposed adjacent the hole having a surface roughness of 4.0 Ra or greater.

2. The track shoe of claim 1, wherein the surface roughness of the rough region is less than 10.0 Ra.

3. The track shoe of claim 1, wherein the ground engaging surface includes a smooth region that is disposed adjacent the rough region, and has a surface roughness of less than 4.0 Ra.

4. The track shoe of claim 3, wherein the rough region encircles the hole.

5. The track shoe of claim 4, wherein the smooth region encircles the rough region.

6. The track shoe of claim 5, wherein the rough region forms an annular ring about the hole.

7. The track shoe of claim 1, wherein the rough region has a stipple pattern.

8. The track shoe of claim 1, wherein the rough region has a knurled pattern.

9. A track shoe for use with a track assembly, the track shoe comprising:
a ground engaging surface;
a track link engaging surface; and
a hole extending through the track shoe from the ground engaging surface to the track link engaging surface;
wherein the ground engaging surface includes a first region surrounding the hole having a first surface roughness, and second region extending from the first region away from the hole having a different surface roughness than the first surface roughness.

10. The track shoe of claim 9, wherein the difference in surface roughness is at least 5.0 Ra.

11. The track shoe of claim 10, wherein the first region has a greater surface roughness than the second region.

12. The track shoe of claim 9, wherein the first region has a circular ring shape.

13. The track shoe of claim 9, wherein the hole is punched.

14. The track shoe of claim 9, wherein the first region has a knurled texture.

15. The track shoe of claim 9, wherein the first region has a sawtooth pattern.

16. The track shoe of claim 9, wherein the track shoe includes a plurality of holes, each including an associated first region disposed about the hole.

17. A track bolt comprising:
a head; and
a shaft extending from the head;
wherein the head includes a surface under the head surrounding the shaft that includes a surface roughness that is 4.0 Ra or greater.

18. The track bolt of claim 17, wherein the surface is knurled.

19. The track bolt of claim 17, wherein the shaft terminates in a free end, and includes external threads extending from the free end toward the head, and the surface roughness does not exceed 10.0 Ra.

20. The track bolt of claim 17, wherein the surface includes a sawtooth pattern.
